(19) United States
(12) Patent Application Publication
(10) Pub. No.: US 2006/0262459 A1
(43) Pub. Date: Nov. 23, 2006

(54) Magnetic detection element and manufacturing the same

(76) Inventors: Kazumi Kamai, Ishikawa-ken (JP); Naoya Hasegawa, Niigata-ken (JP); Eiji Umetsu, Niigata-ken (JP); Kazuaki Ikarashi, Niigata-ken (JP); Ryo Nakabayashi, Niigata-ken (JP)

Correspondence Address: BRINKS HOFER GILSON & LIONE, P.O. BOX 10395, CHICAGO, IL, 60610, US

(21) Appl. No.: 11/413,217

(22) Filed: Apr. 28, 2006

(30) Foreign Application Priority Data
May 2, 2005 (JP) 2005-134345

(51) Int. Cl. G11B 5/33; H04R 31/00

(52) U.S. Cl. 360/324.11; 29/603.01

(57) ABSTRACT

A magnetic detection element capable of increasing the magnetoresistance ratio (ΔR/R) and increasing the reproduction output by applying a surface modification treatment and improving the layer structure of a pinned magnetic layer, as well as a method for manufacturing the same, is provided. A surface of a non-magnetic intermediate layer formed from Ru or the like is subjected to a first treatment, in which the surface is activated by conducting a plasma treatment, and a second treatment, in which the surface is exposed to an atmosphere containing oxygen, a second pinned magnetic layer is allowed to have a two-layer structure composed of a non-magnetic material layer-side magnetic layer formed from Co and a non-magnetic intermediate layer-side magnetic layer formed from a CoFe alloy, and the film thickness ratio of the non-magnetic intermediate layer-side magnetic layer to the second pinned magnetic layer is specified to be 16% to 50%.

### BACKGROUND OF THE INVENTION

1. Field of the Invention

The present invention relates to a magnetic detection element having a laminated film including a pinned magnetic layer in which the magnetization direction is pinned and a free magnetic layer which is disposed on the above-described pinned magnetic layer with a non-magnetic material layer therebetween and in which the magnetization direction is varied due to an external magnetic field.

2. Description of the Related Art

Japanese Unexamined Patent Application Publication No. 2005-38479 (PAJ Translation) discloses a method for manufacturing the above-described magnetic detection element including a pinned magnetic layer (pinned layer), a non-magnetic material layer, and a free magnetic layer. According to the method, the magnetoresistance ratio (ΔR/R) can be increased and, in addition, the coupling magnetic field Hin applied between the pinned magnetic layer and the free magnetic layer can be decreased.

In Japanese Unexamined Patent Application Publication No. 2005-38479, a specific interface is subjected to a surface modification treatment step and is thereby allowed to adsorb oxygen. Examples of similar technologies include Japanese Unexamined Patent Application Publication No. 2003-8106 (US Pub. No. 2003005575) and Japanese Unexamined Patent Application Publication No. 2002-124718 (U.S. Pat. No. 6,661,622).

An increase in the reproduction output is also required in addition to the increase in the magnetoresistance ratio (ΔR/R).

However, Japanese Unexamined Patent Application Publication No. 2005-38479 does not disclose a scheme to increase the above-described reproduction output other than the above-described surface modification step. The same holds true for Japanese Unexamined Patent Application Publication No. 2003-8106 and Japanese Unexamined Patent Application Publication No. 2002-124718.

### SUMMARY OF THE INVENTION

Accordingly, the present invention has been made to overcome the above-described known problems. In particular, it is an object of the present invention to provide a magnetic detection element capable of increasing the magnetoresistance ratio (ΔR/R) and increasing the reproduction output by applying a surface modification treatment and improving the layer structure of a pinned magnetic layer, as well as a method for manufacturing the same.

A magnetic detection element according to an aspect of the present invention has a laminated film including a pinned magnetic layer in which the magnetization direction is pinned and a free magnetic layer which is disposed on the above-described pinned magnetic layer with a non-magnetic material layer therebetween and in which the magnetization direction is varied due to an external magnetic field, wherein at least one predetermined surface of the above-described laminated film, the surface being in a plane direction parallel to the interface between the above-described pinned magnetic layer and the non-magnetic material layer, has been subjected to a first treatment in which the predetermined surface has been activated by a plasma treatment and a second treatment in which the predetermined surface has been exposed to an atmosphere containing oxygen, the above-described pinned magnetic layer includes a first pinned magnetic layer, a second pinned magnetic layer, and a non-magnetic intermediate layer disposed between the above-described first pinned magnetic layer and the second pinned magnetic layer while the above-described second pinned magnetic layer is disposed on the side in contact with the above-described non-magnetic material layer, the above-described second pinned magnetic layer includes a non-magnetic intermediate layer-side magnetic layer in contact with the above-described non-magnetic intermediate layer and a non-magnetic material layer-side magnetic layer in contact with the above-described non-magnetic material layer, the above-described non-magnetic material layer-side magnetic layer is formed from a magnetic material having a resistivity lower than the resistivity of the non-magnetic intermediate layer-side magnetic layer, and when the film thickness of the above-described non-magnetic intermediate layer-side magnetic layer is assumed to be X angstroms and the film thickness of the above-described non-magnetic material layer-side magnetic layer is assumed to be Y angstroms, {X/(X+Y)}×100 (%) is specified to be 16% or more and 50% or less.

In the present aspect, at least one predetermined surface of the above-described laminated film, the surface being in a plane direction parallel to the interface between the above-described pinned magnetic layer and the non-magnetic material layer, is subjected to the above-described first treatment and the second treatment. The interface flatness and the crystallinity can be improved by applying the above-described first treatment and the second treatment. Furthermore, in the present aspect, the above-described second pinned magnetic layer is formed including the non-magnetic intermediate layer-side magnetic layer in contact with the above-described non-magnetic intermediate layer and the non-magnetic material layer-side magnetic layer in contact with the above-described non-magnetic material layer, and the materials and the film thickness ratios of the above-described non-magnetic intermediate layer-side magnetic layer and the non-magnetic material layer-side magnetic layer are optimized. In this manner, in the present aspect, both the magnetoresistance ratio (ΔR/R) and the reproduction output can be increased more appropriately.

In the present aspect, preferably, the above-described first treatment and the second treatment are applied to the predetermined surface of a layer disposed under any one of the above-described second pinned magnetic layer disposed under the above-described non-magnetic material layer, the free magnetic layer, and a second free magnetic layer when the above-described free magnetic layer has a structure in which a first free magnetic layer, the second free magnetic layer, and a non-magnetic intermediate layer disposed between the above-described first free magnetic layer and the second free magnetic layer are included and the above-described second free magnetic layer is disposed on the side in contact with the above-described non-magnetic material layer. In this manner, the interface flatness and the crystallinity of the above-described second pinned magnetic layer, the non-magnetic material layer, the free magnetic layer, and the above-described second free magnetic layer when the above-described free magnetic layer has a laminated ferrimagnetic structure can be improved. Consequently, the above-described magnetoresistance ratio (ΔR/R) can be increased more appropriately.

In the present aspect, preferably, the pinned magnetic layer, the non-magnetic material layer, and the free magnetic layer are laminated in that order from the bottom. In this case, preferably, the above-described predetermined surface is a surface of the above-described non-magnetic intermediate layer constituting the above-described pinned magnetic layer. Preferably, the above-described non-magnetic intermediate layer is formed from at least one type of elements of Ru, Rh, Ir, Cr, Re, and Cu. Oxygen can be adsorbed appropriately on the above-described non-magnetic intermediate layer, and a film of the above-described second pinned magnetic layer is formed on the above-described non-magnetic intermediate layer while taking into oxygen appropriately. At this time, the oxygen concentration has a gradient gradually decreasing from the bottom surface toward the top surface of the above-described second pinned magnetic layer. Previously, the reflection of the conduction electrons (for example, up spin) at the interface between the above-described non-magnetic intermediate layer and the second pinned magnetic layer has been small. However, the reflection of the conduction electrons at the above-described interface is increased because there is the gradient of concentration of oxygen taken into the second pinned magnetic layer as described above. Consequently, the mean free path length of the conduction electrons having up spin can be increased appropriately and, as a result, the magnetoresistance ratio (ΔR/R) can be increased appropriately.

In the present aspect, preferably, the above-described non-magnetic intermediate layer-side magnetic layer is formed from a magnetic material containing at least two types of elements of Co, Fe, and Ni. More preferably, the above-described non-magnetic intermediate layer-side magnetic layer is formed from a CoFe alloy. Preferably, the non-magnetic material layer-side magnetic layer is formed from Co. A preferable example of the present aspect is a structure in which the non-magnetic intermediate layer-side magnetic layer is formed from the CoFe alloy, and the above-described non-magnetic material layer-side magnetic layer is formed from Co. The above-described CoFe alloy tends to be oxidized as compared with Co (that is, Co is resistant to oxidizing as compared with the CoFe alloy). Consequently, the above-described oxygen gradient tends to be formed in the above-described second pinned magnetic layer and, therefore, the above-described magnetoresistance ratio (ΔR/R) can be increased effectively. Furthermore, the above-described second pinned magnetic layer is allowed to have a laminated structure of the CoFe alloy/Co, the film thickness ratio is allowed to become within the above-described range and, thereby, the variation of magnetoresistance (ΔRs) and the minimum magnetoresistance (minRs) can be increased together with the above-described magnetoresistance ratio (ΔR/R). As a result, both the above-described magnetoresistance ratio (ΔR/R) and the reproduction output can be increased appropriately. The relation, ΔRs/minRs=ΔR/R, holds for the variation of magnetoresistance (ΔRs), the minimum magnetoresistance (minRs), and the above-described magnetoresistance ratio (ΔR/R).

In the present aspect, preferably, the second pinned magnetic layer is formed with a film thickness within the range of 15 angstroms or more and 30 angstroms or less.

A method according to another aspect of the present invention is the method for manufacturing a magnetic detection element having a laminated film including a pinned magnetic layer in which the magnetization direction is pinned and a free magnetic layer which is disposed on the above-described pinned magnetic layer with a non-magnetic material layer therebetween and in which the magnetization direction is varied due to an external magnetic field, the method including the steps of subjecting at least one predetermined surface of the above-described laminated film, the surface being in a plane direction parallel to the interface between the above-described pinned magnetic layer and the non-magnetic material layer, to a first treatment in which the above-described predetermined surface is activated by a plasma treatment in a pure Ar atmosphere and, immediately after the above-described first treatment is completed, a second treatment in which the above-described activated predetermined surface is allowed to adsorb oxygen in an atmosphere of oxygen or an atmosphere of a mixed gas of oxygen and an inert gas; forming the above-described pinned magnetic layer including a first pinned magnetic layer, a second pinned magnetic layer, and a non-magnetic intermediate layer disposed between the above-described first pinned magnetic layer and the second pinned magnetic layer while the above-described second pinned magnetic layer is disposed on the side in contact with the above-described non-magnetic material layer; forming the above-described second pinned magnetic layer including a non-magnetic intermediate layer-side magnetic layer in contact with the above-described non-magnetic intermediate layer and a non-magnetic material layer-side magnetic layer in contact with the above-described non-magnetic material layer; forming the above-described non-magnetic material layer-side magnetic layer from a magnetic material having a resistivity lower than the resistivity of the non-magnetic intermediate layer-side magnetic layer, and when the film thickness of the above-described non-magnetic intermediate layer-side magnetic layer is assumed to be X angstroms and the film thickness of the above-described non-magnetic material layer-side magnetic layer is assumed to be Y angstroms, {X/(X+Y)}×100 (%) is specified to be 16% or more and 50% or less.

According to the above-described configuration, since the plasma treatment is conducted in the pure Ar gas atmosphere containing no oxygen, a reaction product due to plasma is not generated. Therefore, the atmosphere in a chamber is stabilized and, in addition, there is no fear of contamination of a target and the inside of the chamber with the plasma reaction product. Consequently, a surfactant effect based on the oxygen adsorption resulting from the second treatment can be exerted adequately. Furthermore, as described above, the materials and the film thickness ratios of the non-magnetic material layer-side magnetic layer and the non-magnetic intermediate layer-side magnetic layer constituting the second pinned magnetic layer are optimized. In this manner, a magnetic detection element capable of increasing both the magnetoresistance ratio (ΔR/R) and the reproduction output can easily be manufactured.

In the present aspect, preferably, the pinned magnetic layer, the non-magnetic material layer, and the free magnetic layer are laminated in that order from the bottom, the above-described predetermined surface is specified to be a surface of the above-described non-magnetic intermediate layer, and the predetermined surface is subjected to the above-described first treatment and the second treatment. In this case, preferably, the above-described non-magnetic intermediate layer is formed from at least one type of elements of Ru, Rh, Ir, Cr, Re, and Cu. It is known that when a predetermined surface is allowed to adsorb oxygen once, the surfactant effect based on oxygen can be maintained to some extent even when some layers are laminated on the above-described predetermined surface. When a surface of the above-described non-magnetic intermediate layer disposed directly below the second pinned magnetic layer is subjected to the above-described first treatment and the second treatment, the above-described surfactant effect can be exerted appropriately on the above-described second pinned magnetic layer as well as the non-magnetic material layer and the free magnetic layer disposed on the second pinned magnetic layer, so that the above-described magnetoresistance ratio (ΔR/R) can be increased more appropriately.

In the present aspect, preferably, the above-described non-magnetic intermediate layer-side magnetic layer is formed from a magnetic material containing at least two types of elements of Co, Fe, and Ni. More preferably, the above-described non-magnetic intermediate layer-side magnetic layer is formed from a CoFe alloy. Furthermore, preferably, the above-described non-magnetic material layer-side magnetic layer is formed from Co. In this manner, both the above-described magnetoresistance ratio (ΔR/R) and the reproduction output can be increased effectively.

In the present aspect, preferably, the above-described second pinned magnetic layer is formed with a film thickness within the range of 15 angstroms or more and 30 angstroms or less.

In the present aspect, at least one predetermined surface of the laminated film constituting the magnetic detection element is subjected to the first treatment in which the above-described predetermined surface is activated by a plasma treatment and the second treatment in which the predetermined surface is exposed to an atmosphere containing oxygen. The above-described pinned magnetic layer is formed including the first pinned magnetic layer, the second pinned magnetic layer in contact with the above-described non-magnetic material layer, and the non-magnetic intermediate layer disposed between the above-described first pinned magnetic layer and the second pinned magnetic layer, the above-described non-magnetic material layer-side magnetic layer is formed from a magnetic material having a resistivity lower than the resistivity of the non-magnetic intermediate layer-side magnetic layer, and when the film thickness of the above-described non-magnetic intermediate layer-side magnetic layer is assumed to be X angstroms and the film thickness of the above-described non-magnetic material layer-side magnetic layer is assumed to be Y angstroms, {X/(X+Y)}×100 (%) is adjusted to become 16% or more and 50% or less.

Consequently, the interface flatness and the crystallinity can be improved, and the magnetoresistance ratio (ΔR/R) can be increased. In addition, the minimum magnetoresistance minRs and the variation of magnetoresistance ΔRs can be increased, and the reproduction output can be increased.

### BRIEF DESCRIPTION OF THE DRAWINGS

FIG. 1 is a schematic diagram showing a laminated film of a single spin-valve type thin film element according to an embodiment of the present invention;

FIG. 2 is a schematic diagram showing a laminated film of a dual spin-valve type thin film element according to an embodiment of the present invention;

FIG. 3 is a partial sectional view of a reproducing head provided with a CIP single spin-valve type thin film element including the laminated film shown in FIG. 1, viewed from the side of a surface facing a recording medium;

FIG. 4 is a partial sectional view of a reproducing head provided with a CIP single spin-valve type thin film element having a configuration different from that shown in FIG. 3, viewed from the side of a surface facing a recording medium;

FIG. 5 is a partial sectional view of a reproducing head provided with a CPP single spin-valve type thin film element including the laminated film shown in FIG. 1, viewed from the side of a surface facing a recording medium;

FIG. 6 is a schematic diagram showing a part of the laminated film shown in FIG. 1 to explain surface-treated portions different from that shown in FIG. 1;

FIG. 7 is a partial sectional view of the laminated film of the single spin-valve type thin film element shown in FIG. 1 during a manufacturing step, viewed from the side of a surface facing a recording medium;

FIG. 8 is a schematic diagram showing the state of adsorption of oxygen on a surface of a non-magnetic intermediate layer;

FIG. 9 is a diagram (partial sectional view) showing a step following the step shown in FIG. 7;

FIG. 10 is a graph showing the relationships between the film thickness X (absolute value) and the minimum magnetoresistance minRs of a non-magnetic intermediate layer-side magnetic layer and between the film thickness ratio and the minRs where the film thickness of a second pinned magnetic layer is fixed at 22 angstroms and the film thickness X of the above-described non-magnetic intermediate layer-side magnetic layer is changed variously for each of a CIP spin-valve type thin film element of Example (in which a non-magnetic intermediate layer surface has been subjected to a surface modification treatment) and a CIP spin-valve type thin film element of Comparative example (in which a non-magnetic intermediate layer surface has not been subjected to a surface modification treatment);

FIG. 11 is a graph showing the relationships between the film thickness X (absolute value) and the variation of magnetoresistance ΔRs of a non-magnetic intermediate layer-side magnetic layer and between the film thickness ratio and the ΔRs where the film thickness of a second pinned magnetic layer is fixed at 22 angstroms and the film thickness X of the above-described non-magnetic intermediate layer-side magnetic layer is changed variously for each of a CIP spin-valve type thin film element of Example (in which a non-magnetic intermediate layer surface has been subjected to a surface modification treatment) and a CIP spin-valve type thin film element of Comparative example (in which a non-magnetic intermediate layer surface has not been subjected to a surface modification treatment); and

FIG. 12 is a graph showing the relationships between the film thickness X (absolute value) and the magnetoresistance ratio (ΔR/R) of a non-magnetic intermediate layer-side magnetic layer and between the film thickness ratio and the ΔR/R where the film thickness of a second pinned magnetic layer is fixed at 22 angstroms and the film thickness X of the above-described non-magnetic intermediate layer-side magnetic layer is changed variously for each of a CIP spin-valve type thin film element of Example (in which a non-magnetic intermediate layer surface has been subjected to a surface modification treatment) and a CIP spin-valve type thin film element of Comparative example (in which a non-magnetic intermediate layer surface has not been subjected to a surface modification treatment).

### DESCRIPTION OF THE PREFERRED EMBODIMENTS

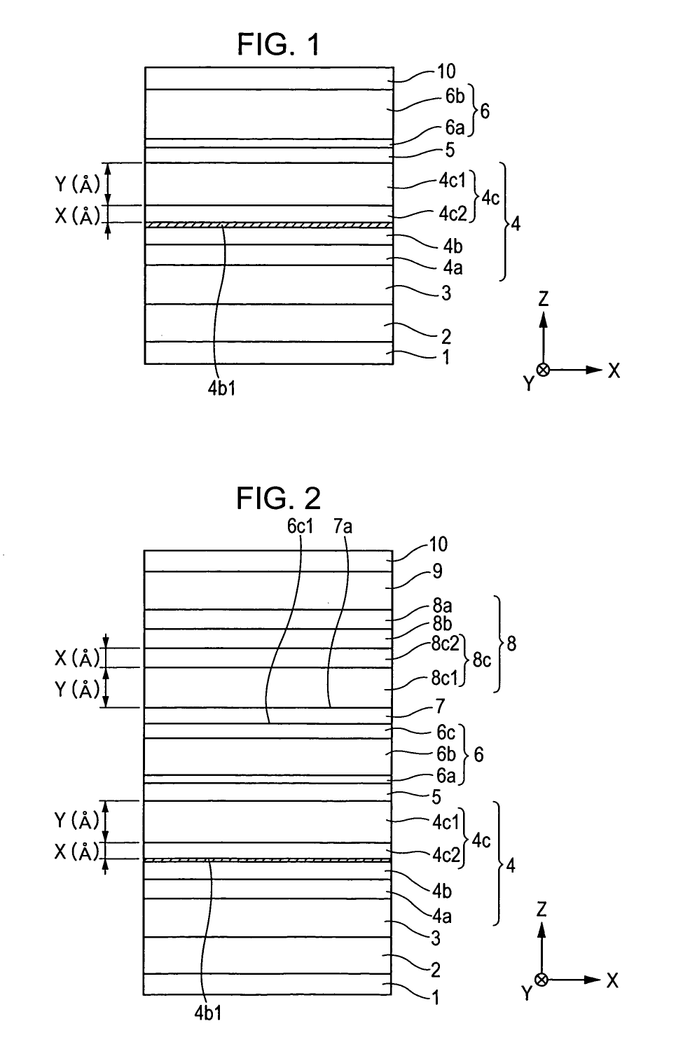

FIG. 1 is a schematic diagram showing a laminated film of a single spin-valve type thin film element according to an embodiment of the present invention.

The single spin-valve type thin film element is disposed at, for example, a trailing-side end portion of a flying slider disposed in a hard disk device and is used for detecting a recording magnetic field of a hard disk or the like. In the drawing, the X direction is a track width direction, the Y direction is a direction of a leakage magnetic field from a magnetic recording medium (height direction), and the Z direction is a movement direction of the magnetic recording medium, e.g., a hard disk, as well as a lamination direction of individual layers of the above-described single spin-valve type thin film element.

In FIG. 1, a substrate layer 1 formed from a non-magnetic material, e.g., at least one type of elements of Ta, Hf, Nb, Zr, Ti, Mo, and W, is disposed as a lowermost layer. A seed layer 2 is disposed on this substrate layer 1. The above-described seed layer 2 is formed from NiFeCr or Cr. When the above-described seed layer 2 is formed from NiFeCr, the above-described seed layer 2 has a face-centered cubic (fcc) structure in which an equivalent crystal plane represented by a {111} surface is preferentially oriented in a direction parallel to the film surface. When the above-described seed layer 2 is formed from Cr, the above-described seed layer 2 has a body-centered cubic (bcc) structure in which an equivalent crystal plane represented by a {110} surface is preferentially oriented in a direction parallel to the film surface.

The substrate layer 1 has a structure close to an amorphous state. However, this substrate layer 1 may not be disposed.

Preferably, an antiferromagnetic layer 3 disposed on the above-described seed layer 2 is formed from an antiferromagnetic material containing an element X (where X represents at least one type of elements of Pt, Pd, Ir, Rh, Ru, and Os) and Mn.

These X—Mn alloys including platinum group elements have excellent properties for antiferromagnetic materials. For example, excellent corrosion resistance is exhibited, the blocking temperature is high and, furthermore, the exchange coupling magnetic field (Hex) can be increased.

The above-described antiferromagnetic layer 3 may be formed from an antiferromagnetic material containing the element X, an element X′ (where X′ represents at least one type of elements of Ne, Ar, Kr, Xe, Be, B, C, N, Mg, Al, Si, P, Ti, V, Cr, Fe, Co, Ni, Cu, Zn, Ga, Ge, Zr, Nb, Mo, Ag, Cd, Sn, Hf, Ta, W, Re, Au, Pb, and rare-earth elements), and Mn.

Preferably, the atomic percent of the element X or the element X+X′ in the above-described antiferromagnetic layer 3 is set at 15 atomic percent or more and 60 atomic percent or less. More preferably, the atomic percent is set at 20 atomic percent or more and 56.5 atomic percent or less.

A pinned magnetic layer 4 is formed with a multilayer structure composed of a first pinned magnetic layer 4a, a non-magnetic intermediate layer 4b, and a second pinned magnetic layer 4c. The magnetization directions of the above-described first pinned magnetic layer 4a and the second pinned magnetic layer 4c are brought into a mutually antiparallel state by an exchange coupling magnetic field at the interface to the above-described antiferromagnetic layer 3 and an antiferromagnetic exchange coupling magnetic field (RKKY interaction) through the non-magnetic intermediate layer 4b. This is referred to as a so-called laminated ferrimagnetic structure. By this configuration, the magnetization of the above-described pinned magnetic layer 4 can be brought into a stable state, and an exchange coupling magnetic field generated at the interface between the above-described pinned magnetic layer 4 and the antiferromagnetic layer 3 can apparently be increased.

The above-described first pinned magnetic layer 4a is formed with a thickness of about 12 angstroms to 24 angstroms, for example, and the non-magnetic intermediate layer 4b is formed with a thickness of about 8 angstroms to 10 angstroms. The above-described second pinned magnetic layer 4c will be described below.

The above-described first pinned magnetic layer 4a is formed from a ferromagnetic material, e.g., CoFe, NiFe, or CoFeNi. The non-magnetic intermediate layer 4b is formed from a non-magnetic electrically conductive material, e.g., Ru, Rh, Ir, Cr, Re, or Cu.

A film of the second pinned magnetic layer 4c is formed taking on a two-layer structure composed of a non-magnetic material layer-side magnetic layer 4c1 in contact with a non-magnetic material layer 5 and a non-magnetic intermediate layer-side magnetic layer 4c2. The above-described non-magnetic material layer-side magnetic layer 4c1 is formed from a magnetic material having a resistivity lower than the resistivity of the above-described non-magnetic intermediate layer-side magnetic layer 4c2. Preferably, the material for the above-described non-magnetic material layer-side magnetic layer 4c1 is resistant to oxidizing as compared with the material for the above-described non-magnetic intermediate layer-side magnetic layer 4c2.

Preferably, the above-described non-magnetic intermediate layer-side magnetic layer 4c2 is formed from a magnetic alloy containing at least two types of elements of Co, Fe, and Ni. In particular, in order to increase the above-described RKKY interaction, preferably, both the above-described first pinned magnetic layer 4a and the non-magnetic intermediate layer-side magnetic layer 4c2 are formed from a CoFe alloy. When the first pinned magnetic layer 4a is formed from the CoFe alloy, preferably, the composition ratio of Co is within the range of 20 atomic percent to 90 atomic percent and the remainder is the composition ratio of Fe. When the above-described non-magnetic intermediate layer-side magnetic layer 4c2 is formed from the CoFe alloy, preferably, the composition ratio of Co is within the range of 20 atomic percent to 90 atomic percent and the remainder is the composition ratio of Fe.

The above-described non-magnetic material layer-side magnetic layer 4c1 may be either a magnetic alloy or a magnetic element simple substance. However, the magnetic element simple substance can appropriately reduce the resistivity as compared with the above-described non-magnetic intermediate layer-side magnetic layer 4c2. Preferably, the above-described non-magnetic material layer-side magnetic layer 4c1 is formed from any one type of elements of Ni, Fe, and Co. More preferably, the above-described non-magnetic material layer-side magnetic layer 4c1 is formed from Co in order to improve the magnetoresistance ratio (ΔR/R) and the reproduction output.

The non-magnetic material layer 5 disposed on the above-described pinned magnetic layer 4 is formed from Cu, Au, or Ag. The non-magnetic material layer 5 formed from Cu, Au, or Ag has a face-centered cubic (fcc) structure in which an equivalent crystal plane represented by a {111} surface is preferentially oriented in a direction parallel to the film surface.

A free magnetic layer 6 is disposed on the above-described non-magnetic material layer 5. The above-described free magnetic layer 6 is composed of a soft magnetic layer 6b formed from a magnetic material, e.g., a NiFe alloy or a CoFe alloy, and a diffusion prevention layer 6a formed from Co, CoFe, or the like and disposed between the above-described soft magnetic layer 6b and the above-described non-magnetic material layer 5. The film thickness of the above-described free magnetic layer 6 is 20 angstroms to 60 angstroms. The free magnetic layer 6 may have a laminated ferrimagnetic structure in which a plurality of magnetic layers are laminated with non-magnetic intermediate layers therebetween. A track width Tw is determined by the width dimension of the above-described free magnetic layer 6 in the track-width direction (the X direction shown in the drawing).

Reference numeral 10 denotes a protective layer formed from Ta or the like.

The above-described free magnetic layer 6 has been magnetized in a direction parallel to the track-width direction (the X direction shown in the drawing).

On the other hand, the first pinned magnetic layer 4a and the second pinned magnetic layer 4c constituting the pinned magnetic layer 4 have been magnetized in a direction parallel to the height direction (the Y direction shown in the drawing). Since the above-described pinned magnetic layer 4 has the laminated ferrimagnetic structure, the first pinned magnetic layer 4a and the second pinned magnetic layer 4c have been magnetized antiparallel to each other. The magnetization of the above-described pinned magnetic layer 4 is pinned (the magnetization is not varied due to an external magnetic field), but the magnetization of the above-described free magnetic layer 6 is varied due to an external magnetic field.

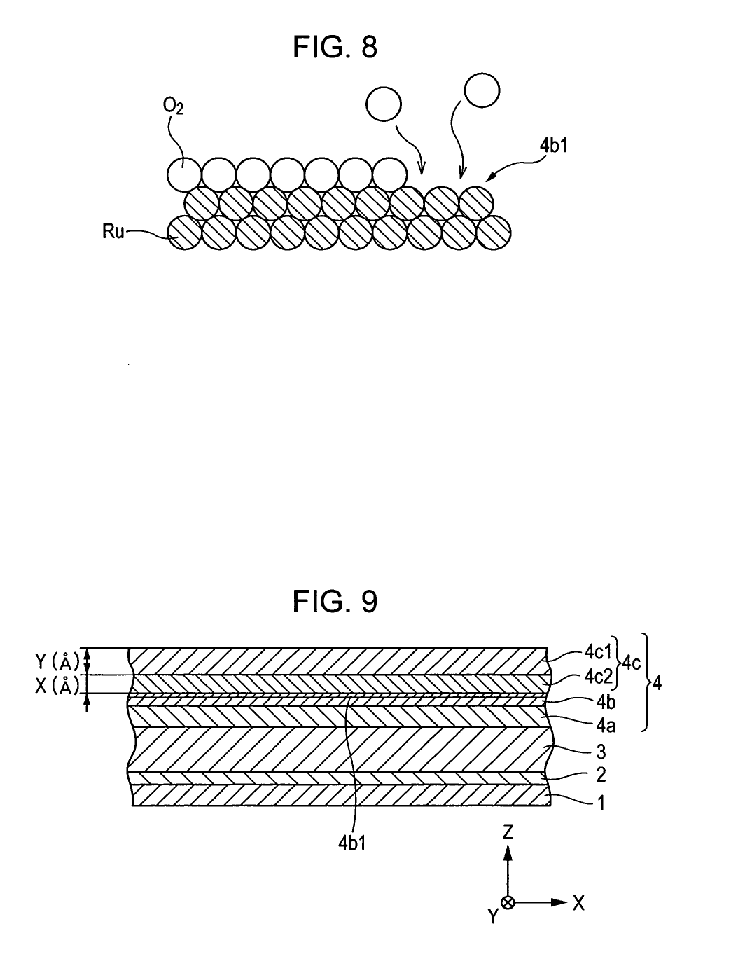

For the portion in an embodiment shown in FIG. 1, a surface 4b1 of the above-described non-magnetic intermediate layer 4b is subjected to a surface modification treatment. The explanation will be provided with reference to the manufacturing step diagrams shown in FIG. 7 and FIG. 8 as well. As shown in FIG. 7, films of the seed layer 2, the antiferromagnetic layer 3, the first pinned magnetic layer 4a, and the non-magnetic intermediate layer 4b are formed on the above-described substrate layer 1. For example, the above-described non-magnetic intermediate layer 4b is formed from Ru. After the film of the above-described non-magnetic intermediate layer 4b is formed from Ru, a pure Ar gas is introduced into a vacuum chamber, and plasma with a low level of energy, at which sputtering does not occur, is generated on the surface 4b1 of the above-described non-magnetic intermediate layer 4b. Plasma particles come into collision with the surface 4b1 of the above-described non-magnetic intermediate layer 4b so as to activate Ru atoms present on the above-described surface 4b1 and, thereby, the rearrangement of the Ru atoms on the above-described surface 4b1 is facilitated. In this manner, the surface roughness of the surface 4b1 of the above-described non-magnetic intermediate layer 4b is reduced.

Very small amounts of oxygen in addition to the pure Ar gas is flowed into the vacuum chamber immediately after the plasma treatment. Consequently, since the above-described surface 4b1 has been activated by the above-described plasma treatment, oxygen is adsorbed on the above-described surface 4b1 in an atmosphere of a mixed gas of, for example, a pure Ar gas and oxygen (refer to FIG. 8). The oxygen adsorbed on the above-described surface 4b1 functions as a surfactant.

As described above, the surface 4b1 of the above-described non-magnetic intermediate layer 4b has been subjected to the surface modification treatment composed of the first treatment in which the above-described surface 4b1 has been activated by the plasma treatment and the second treatment in which the surface 4b1 has been exposed to the atmosphere containing oxygen. In FIG. 1, the location of the surface 4b1 of the above-described non-magnetic intermediate layer 4b (the interface between the above-described non-magnetic intermediate layer 4b and the non-magnetic intermediate layer-side magnetic layer 4c2) is indicated by a thick line, and this schematically represents that the above-described surface 4b1 has been subjected to the surface modification treatment.

When the surface 4b1 of the above-described non-magnetic intermediate layer 4b is subjected to the above-described surface modification treatment, the surfactant effect is exerted appropriately, and the interface flatness and the crystallinity of the second pinned magnetic layer 4c, non-magnetic material layer 5, and the free magnetic layer 6 laminated on the above-described non-magnetic intermediate layer 4b are improved. As shown in FIG. 1, the above-described second pinned magnetic layer 4c is formed taking on the two-layer structure composed of the non-magnetic material layer-side magnetic layer 4c1 and the non-magnetic intermediate layer-side magnetic layer 4c2. The above-described non-magnetic material layer-side magnetic layer 4c1 is formed from a magnetic material having a resistivity lower than the resistivity of the above-described non-magnetic intermediate layer-side magnetic layer 4c2. Furthermore, preferably, the above-described non-magnetic material layer-side magnetic layer 4c1 is formed from a material resistant to oxidizing as compared with the above-described non-magnetic intermediate layer-side magnetic layer 4c2. Specifically, the above-described non-magnetic material layer-side magnetic layer 4c1 is formed from Co, and the above-described non-magnetic intermediate layer-side magnetic layer 4c2 is formed from the CoFe alloy. Consequently, in the above-described second pinned magnetic layer 4c, the concentration of very small amounts of oxygen taken therein has a gradient gradually decreasing from the bottom surface toward the top surface of the above-described second pinned magnetic layer 4c. For these reasons, conduction electrons having up spin tend to be reflected at the interface between the above-described second pinned magnetic layer 4c and the non-magnetic intermediate layer 4b, and the mean free path is increased. As a result, the magnetoresistance ratio (ΔR/R) can be improved appropriately.

Furthermore, in the embodiment shown in FIG. 1, when the film thickness of the above-described non-magnetic intermediate layer-side magnetic layer 4c2 is assumed to be X angstroms and the film thickness of the above-described non-magnetic material layer-side magnetic layer 4c1 is assumed to be Y angstroms, the film thickness ratio of the non-magnetic intermediate layer-side magnetic layer 4c2 to the second pinned magnetic layer 4c, {X/(X+Y)}×100 (%), is specified to be within the range of 16% to 50%. Since the resistivity of the above-described non-magnetic material layer-side magnetic layer 4c1 is lower than the resistivity of the non-magnetic intermediate layer-side magnetic layer 4c2, when the film thickness ratio of the above-described non-magnetic material layer-side magnetic layer 4c1 is increased, the mean free path of the up spin is increased. Consequently, although the magnetoresistance ratio (ΔR/R) can be increased, the variation of magnetoresistance (ΔRs) and the minimum magnetoresistance (minRs) are decreased. The relationship, ΔRs/minRs=ΔR/R, holds. If the above-described ΔRs and minRs are decreased, the reproduction output is decreased. Therefore, it is not desirable that the film thickness ratio of the above-described non-magnetic material layer-side magnetic layer 4c1 becomes too large (the film thickness of the non-magnetic intermediate layer-side magnetic layer is too small). As described above, by adjusting the film thickness ratio of the non-magnetic intermediate layer-side magnetic layer 4c2 to the second pinned magnetic layer 4c within the range of 16% to 50%, the magnetoresistance ratio (ΔR/R) can be increased. In addition, the ΔRs and the minRs can also be increased and both the magnetoresistance ratio (ΔR/R) and the reproduction output can be increased appropriately. Preferably, the film thickness ratio of the non-magnetic intermediate layer-side magnetic layer 4c2 to the above-described second pinned magnetic layer 4c, {X/(X+Y)}×100 (%), is within the range of 18.2% to 45.5% because both the magnetoresistance ratio (ΔR/R) and the reproduction output can be increased appropriately.

Preferably, The above-described non-magnetic intermediate layer 4b is formed from at least one type of elements of Ru, Rh, Ir, Cr, Re, and Cu. It is preferable that the above-described non-magnetic intermediate layer 4b is formed from at least one type of elements of Ru, Rh, Ir, Cr, and Re among them. Since these elements have a property resistant to oxidizing, an oxidized layer is not generated on the surface 4b1 of the above-described non-magnetic intermediate layer 4b even when the amount of the supply of oxygen is increased by increasing the oxygen flow time, for example. Therefore, the above-described surface 4b1 is allowed to adsorb an adequate amount of oxygen.

Preferably, the film thickness of the above-described second pinned magnetic layer 4c is 15 angstroms or more and 30 angstroms or less. Since the above-described first pinned magnetic layer 4a is formed with a film thickness of about 12 angstroms to 24 angstroms, as described above, if the film thickness of the above-described second pinned magnetic layer 4c becomes less than 15 angstroms, the difference in film thicknesses between the second pinned magnetic layer 4c and the first pinned magnetic layer 4a is increased. Consequently, the RKKY interaction, which takes place between the above-described second pinned magnetic layer 4c and the first pinned magnetic layer 4a, is reduced and, undesirably, the magnetization of the above-described first pinned magnetic layer 4a and the second pinned magnetic layer 4c cannot be pinned appropriately. In the case where the single spin-valve type thin film element having the laminated film shown in FIG. 1 is of current in the plane (CIP) type, if the film thickness of the above-described second pinned magnetic layer 4c becomes too thick, the ΔRs and the minRs are decreased, and the reproduction output is decreased. Therefore, it is preferable that the film thickness of the above-described second pinned magnetic layer 4c is 30 angstroms or less. The CIP type refers to a type in which a current is passed through the laminated film shown in FIG. 1 in a direction parallel to the film surface. On the other hand, the current perpendicular to the plane (CPP) type refers to a type in which a current is passed in a direction perpendicular to the film surface of each layer of the above-described laminated film.

The magnetic moment will be discussed. Preferably, the magnetic moment (saturation magnetization Ms×film thickness t) of the first pinned magnetic layer 4a and the magnetic moment (saturation magnetization Ms×film thickness t) of the second pinned magnetic layer 4c satisfy the magnetic moment of the second pinned magnetic layer 4c≧the magnetic moment of the first pinned magnetic layer 4a. However, when the magnetic moment of the second pinned magnetic layer 4c—the magnetic moment of the first pinned magnetic layer 4a takes on a large value, undesirably, the unidirectional exchange bias magnetic field Hex* becomes small. The unidirectional exchange bias magnetic field refers to a magnitude of magnetic field including, for example, the coupling magnetic field in the RKKY interaction because the above-described pinned magnetic layer has the laminated ferrimagnetic structure, other than the exchange coupling magnetic field generated between the above-described pinned magnetic layer and the antiferromagnetic layer. When the magnetic moment of the first pinned magnetic layer 4a becomes too large, undesirably, the exchange coupling magnetic field generated between the first pinned magnetic layer 4a and the antiferromagnetic layer 3 becomes small.

It is preferable that the surfactant effect based on oxygen is exerted on the second pinned magnetic layer 4c, the non-magnetic material layer 5, and the free magnetic layer 6 appropriately. Therefore, for the structure of the laminated film shown in FIG. 1, preferably, the surface 4b1 of the non-magnetic intermediate layer 4b disposed directly below the above-described second pinned magnetic layer 4c is subjected to the above-described surface modification treatment. However, it is known that when a predetermined surface set at will is allowed to adsorb oxygen once, the above-described surfactant effect can be maintained to some extent even when some layers are laminated on the above-described predetermined surface. Therefore, it is believed that the above-described surfactant effect can be expected even when the above-described surface modification treatment is applied to the interface between layers located under the surface 4b1 of the above-described non-magnetic intermediate layer 4b or a predetermined surface in a layer.

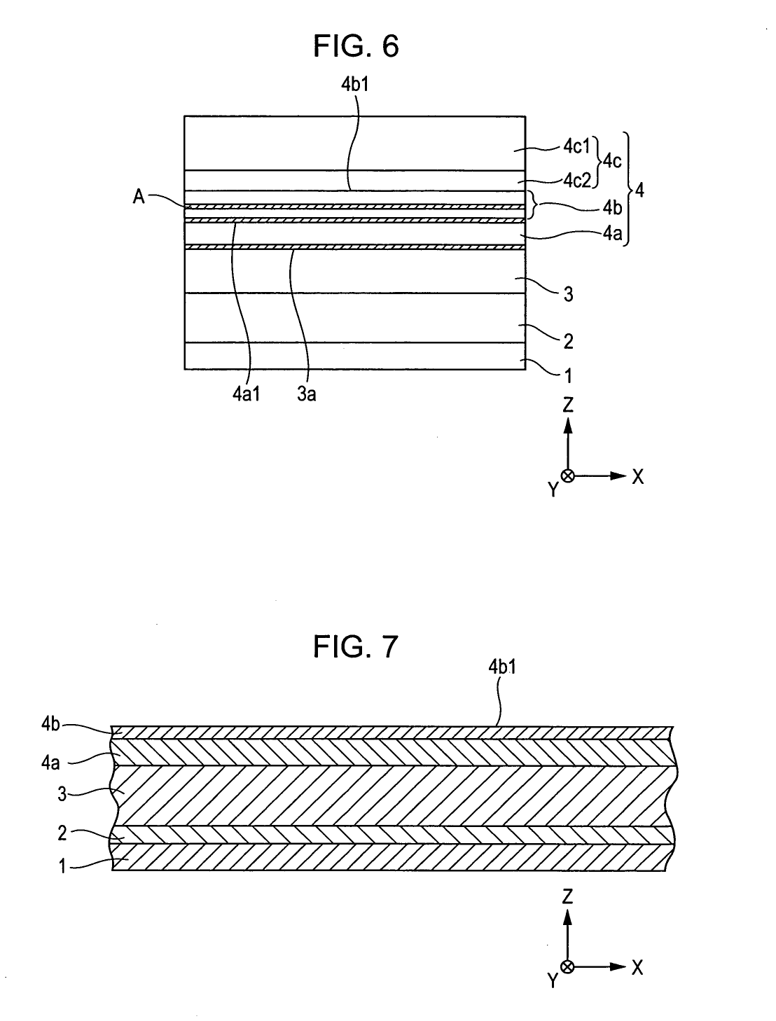

In an embodiment shown in FIG. 6, the surface 4b1 of the above-described non-magnetic intermediate layer 4b has not been subjected to the above-described surface modification treatment. In FIG. 6, the above-described surface modification treatment has been applied to a predetermined surface indicated by reference numeral A. The surface A is formed in the above-described non-magnetic intermediate layer 4b and in a plane direction parallel to the interface between the pinned magnetic layer 4 and the antiferromagnetic layer 3 (in a plane direction parallel to the X-Y plane shown in the drawing). A film of the above-described non-magnetic intermediate layer 4b is formed partway, a surface of the non-magnetic intermediate layer 4b at that time is subjected to the above-described surface modification treatment, and the remainder of the film of the non-magnetic intermediate layer 4b is formed on the above-described surface having been subjected to the above-described surface modification treatment, so that the surface A having been subjected to the surface modification treatment can be formed in the above-described non-magnetic intermediate layer 4b. Alternatively, as shown in FIG. 6, a surface 4a1 of the above-described first pinned magnetic layer 4a and a surface 3a of the antiferromagnetic layer 3 may be subjected to the above-described surface modification treatment. Since the surfactant effect is not significantly expected when a surface vulnerable to oxidation is subjected to the above-described surface modification treatment, in the case where, for example, the first pinned magnetic layer 4a is formed from a material, e.g., a CoFe alloy, relatively vulnerable to oxidation, it is believed to be better that the surface 4a1 of the above-described first pinned magnetic layer 4a is not subjected to the above-described surface modification treatment.

In a laminated film of a spin-valve type thin film element according to an embodiment shown in FIG. 2, a substrate layer 1, a seed layer 2, an antiferromagnetic layer 3, a pinned magnetic layer 4, a non-magnetic material layer 5, a free magnetic layer 6, a non-magnetic material layer 7, a pinned magnetic layer 8, an antiferromagnetic layer 9, and a protective layer 10 are laminated in that order from the bottom. The free magnetic layer 6 shown in FIG. 2 has a three-layer structure, and diffusion prevention layers 6a and 6c are disposed on the top and bottom of the soft magnetic layer 6b. The above-described pinned magnetic layer 8 located above the free magnetic layer 6 has a laminated ferrimagnetic structure formed from a first pinned magnetic layer 8a, a non-magnetic intermediate layer 8b, and a second pinned magnetic layer 8c. Furthermore, the above-described second pinned magnetic layer 8c is formed having a two-layer structure composed of a non-magnetic material layer-side magnetic layer 8c1 and a non-magnetic intermediate layer-side magnetic layer 8c2. The above-described non-magnetic material layer-side magnetic layer 8c1 is formed from, for example, Co, and the non-magnetic intermediate layer-side magnetic layer 8c2 is formed from, for example, a CoFe alloy.

In the embodiment shown in FIG. 2, the above-described surface modification treatment has been applied to a surface 4b1 of the non-magnetic intermediate layer 4b of the above-described pinned magnetic layer 4 located under the free magnetic layer 6. When the above-described surface modification treatment is applied to the surface 4b1 of the above-described non-magnetic intermediate layer 4b, the surfactant effect is exerted appropriately, and the interface flatness and the crystallinity of the second pinned magnetic layer 4c, the non-magnetic material layer 5, the free magnetic layer 6, the non-magnetic material layer 7, and the pinned magnetic layer 8 laminated on the above-described non-magnetic intermediate layer 4b are improved. In the above-described second pinned magnetic layer 4c, the concentration of very small amounts of oxygen taken therein has a gradient gradually decreasing from the bottom surface toward the top surface of the above-described second pinned magnetic layer 4c. For these reasons, the mean free path of conduction electrons having up spin is increased, and the magnetoresistance ratio (ΔR/R) can be improved appropriately.

Furthermore, in the embodiment shown in FIG. 2, when the film thicknesses of the above-described non-magnetic intermediate layer-side magnetic layers 4c2 and 8c2 are assumed to be X angstroms and the film thicknesses of the above-described non-magnetic material layer-side magnetic layers 4c1 and 8c1 are assumed to be Y angstroms, the film thickness ratio of the non-magnetic intermediate layer-side magnetic layers 4c2 and 8c2 to the second pinned magnetic layers 4c and 8c, {X/(X+Y)}×100 (%), is specified to be within the range of 16% to 50%. Since the resistivity of the above-described non-magnetic material layer-side magnetic layers 4c1 and 8c1 is lower than the resistivity of the non-magnetic intermediate layer-side magnetic layers 4c2 and 8c2, when the film thickness ratio of the above-described non-magnetic material layer-side magnetic layers 4c1 and 8c1 is increased, the mean free path of the up spin is increased. Consequently, although the magnetoresistance ratio (ΔR/R) can be increased, the variation of magnetoresistance (ΔRs) and the minimum magnetoresistance (minRs) are decreased. As described above, by adjusting the film thickness ratio of the non-magnetic intermediate layer-side magnetic layers 4c2 and 8c2 to the second pinned magnetic layers 4c and 8c within the range of 16% to 50%, the magnetoresistance ratio (ΔR/R) can be increased. In addition, the ΔRs and the minRs can also be increased and both the magnetoresistance ratio (ΔR/R) and the reproduction output can be increased appropriately. Preferably, the film thickness ratio of the non-magnetic intermediate layer-side magnetic layers 4c2 and 8c2 to the above-described second pinned magnetic layers 4c and 8c, {X/(X+Y)}×100 (%), is within the range of 18.2% to 45.5% because both the magnetoresistance ratio (ΔR/R) and the reproduction output can be increased appropriately. When the film thickness ratios of the non-magnetic intermediate layer-side magnetic layers 4c2 and 8c2 to the above-described second pinned magnetic layers 4c and 8c are within the range of 16% to 50%, the film thickness ratio of the non-magnetic intermediate layer-side magnetic layer 4c2 to the above-described second pinned magnetic layer 4c is not necessarily equal to the film thickness ratio of the non-magnetic intermediate layer-side magnetic layers 8c2 to the above-described second pinned magnetic layers 8c. As a matter of course, the film thickness of the second pinned magnetic layer 4c is not necessarily equal to the film thickness of the second pinned magnetic layer 8c as well.

The spin-valve type thin film element shown in FIG. 2 has a structure referred to as a dual spin-valve type thin film element. In the embodiment shown in FIG. 2, since the distance from the surface 4b1 of the non-magnetic intermediate layer 4b having been subjected to the surface modification treatment to the second pinned magnetic layer 8c of the above-described pinned magnetic layer 8 disposed above the free magnetic layer 6 is long, it is believed that the surfactant effect on the above-described second pinned magnetic layer 8c is smaller than that on the second pinned magnetic layer 4c of the pinned magnetic layer 4 disposed under the free magnetic layer 6. Therefore, in order to improve the surfactant effect exerted on the above-described second pinned magnetic layer 8c, it is preferable that the above-described surface modification treatment is applied to, for example, a surface 7a of the non-magnetic material layer 7 and a surface 6c1 of the diffusion prevention layer 6c of the free magnetic layer 6.

However, the top surfaces and the bottom surfaces of the non-magnetic material layers 5 and 7 are formed to become significantly delicate to obtain a large magnetoresistance ratio (ΔR/R), and when impurities enter the top surfaces and the bottom surfaces of the above-described non-magnetic material layers 5 and 7, the magnetoresistance ratio (ΔR/R) tends to be decreased for that reason only. Consequently, it is preferable that the top surfaces and the bottom surfaces of the non-magnetic material layers 5 and 7 are not subjected to the above-described surface modification treatment and other parts are subjected to the above-described surface modification treatment, if possible.

It is desirable that the above-described surface modification treatment is applied to a surface resistant to oxidization as much as possible. Therefore, preferably, the above-described surface modification treatment is applied to the surface 4b1 of the non-magnetic intermediate layer 4b formed from Ru or the like. The embodiment in which the above-described non-magnetic intermediate layer 4b is located below the second pinned magnetic layer 4c is the form shown in FIG. 1, wherein the pinned magnetic layer, the non-magnetic material layer, and the free magnetic layer are laminated in that order from the bottom. The form shown in FIG. 1 is believed to be most suitable for obtaining the surfactant effect based on oxygen.

As a matter of course, in a configuration, a free magnetic layer, a non-magnetic material layer, and a pinned magnetic layer may be laminated in that order from the bottom. Whatever the structure of the laminated film is, preferably, the above-described surface modification treatment is applied to a predetermined surface of a layer disposed under any one of the above-described second pinned magnetic layer disposed under the non-magnetic material layer, the free magnetic layer, and a second free magnetic layer in the case of a structure (laminated ferrimagnetic structure) in which the above-described free magnetic layer includes a first free magnetic layer, the second free magnetic layer, and a non-magnetic intermediate layer disposed between the above-described first free magnetic layer and the second free magnetic layer, and the second free magnetic layer is disposed on the side in contact with the above-described non-magnetic material layer, because the interface flatness and the crystallinity of the above-described second pinned magnetic layer, the non-magnetic material layer, the free magnetic layer, and the second free magnetic layer when the free magnetic layer has the laminated ferrimagnetic structure.

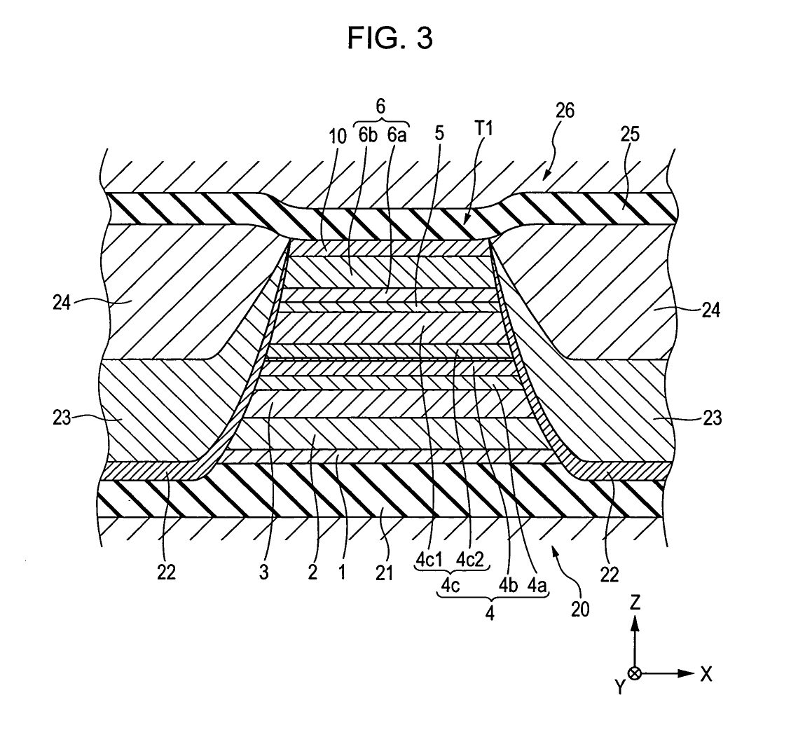

FIG. 3 is a partial sectional view of a reproducing head provided with a single spin-valve type thin film element including the laminated film shown in FIG. 1, viewed from the side of a surface facing a recording medium. The above-described single spin-valve type thin film element is of a CIP type.

Reference numeral 20 denotes a lower shield layer formed from a magnetic material, and a lower gap layer 21 formed from an insulating material, e.g., Al₂O₃, is disposed on the above-described lower shield layer 20. A laminated film T1 having the same structure as that of the laminated film shown in FIG. 1 is disposed on the above-described lower gap layer 21.

In the above-described laminated film T1, a substrate layer 1, a seed layer 2, an antiferromagnetic layer 3, a pinned magnetic layer 4, a non-magnetic material layer 5, a free magnetic layer 6, and a protective layer 10 are laminated in that order from the bottom. Bias substrate layers 22 formed from Cr, W, a W—Ti alloy, a Fe—Cr alloy, or the like are disposed on both side-end surfaces of the above-described laminated film T1 in the track-width direction (X direction shown in the drawing). Hard bias layers 23 and electrode layers 24 are laminated on the above-described bias substrate layers 22. The above-described hard bias layer 23 is formed from a cobalt-platinum (Co—Pt) alloy, a cobalt-chromium-platinum (Co—Cr—Pt) alloy, or the like. The above-described electrode layer 24 is formed from an electrically conductive material, e.g., Cr, W, Au, Rh, or α—Ta. The above-described spin-valve type thin film element is composed of the above-described laminated film T1, the bias substrate layers 22, the hard bias layers 23, and the above-described electrode layers 24.

As shown in FIG. 3, an upper gap layer 25 formed from an insulating material, e.g., Al₂O₃, is disposed over the above-described laminated film T1 and the electrode layers 24, and an upper shield layer 26 formed from a magnetic material is disposed on the above-described upper gap layer 25.

In the embodiment shown in FIG. 3, the magnetization of the free magnetic layer 6 is aligned in a track-width direction (X direction shown in the drawing) by longitudinal bias magnetic fields from the above-described hard bias layers 23. The magnetization of the free magnetic layer 6 is varied with high sensitivity to the signal magnetic field (external magnetic field) from a recording medium. On the other hand, the magnetization of the pinned magnetic layer 4 is pinned in a direction parallel to the height direction (Y direction shown in the drawing).

An electric resistance is varied in relation to variations in the magnetization direction of the free magnetic layer 6 and the pinned magnetization direction of the pinned magnetic layer 4 (in particular, the pinned magnetization direction of the second pinned magnetic layer 4c). A leakage magnetic field from a recording medium is detected by a change in voltage or a change in current based on a change in the value of this electric resistance.

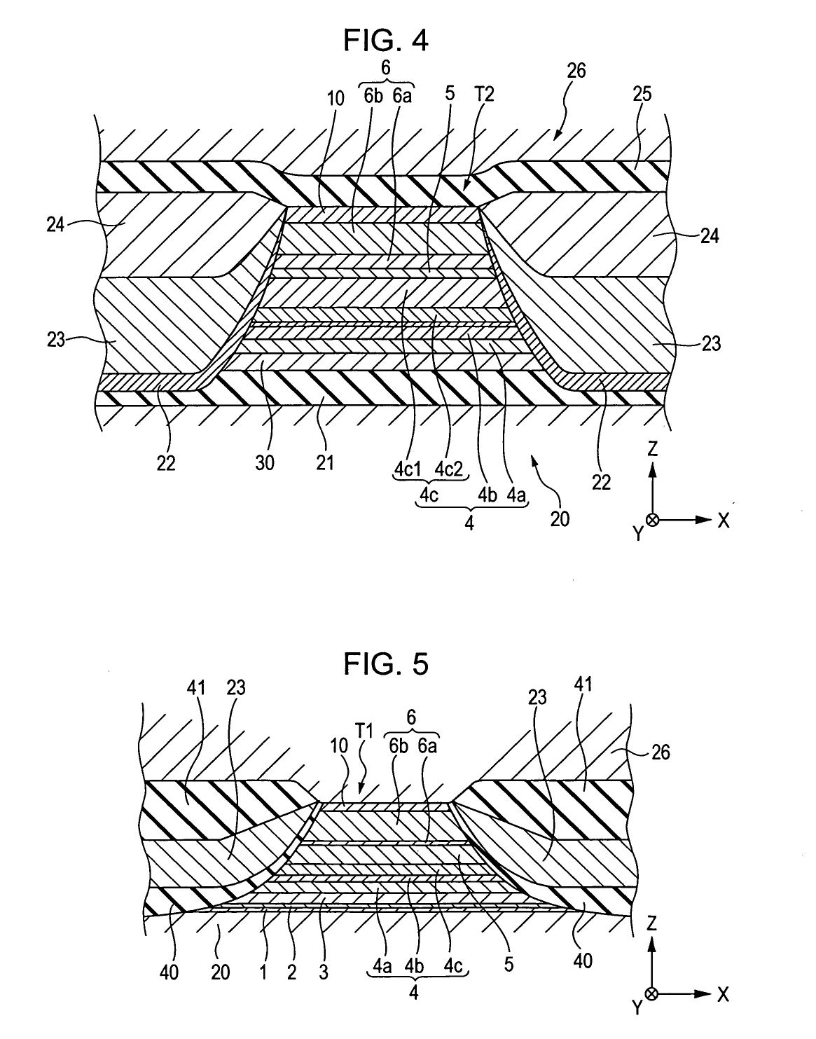

FIG. 4 is a partial sectional view of a reproducing head provided with a CIP single spin-valve type thin film element having a configuration different from that shown in FIG. 3, viewed from the side of a surface facing a recording medium.

In contrast to the configuration shown in FIG. 3, the antiferromagnetic layer 3 is not disposed in the laminated film T2 in FIG. 4. FIG. 4 shows a so-called self-pinning type magnetic detection element, wherein the magnetization of the pinned magnetic layer 4 is pinned by the uniaxial anisotropy of the pinned magnetic layer itself.

In FIG. 4, a magnetostriction-enhancing layer 30 formed from a simple substance element, e.g., Pt, Au, Pd, Ag, Ir, Rh, Ru, Re, Mo, or W, an alloy composed of at least two types of these elements, or an R—Mn (where the element R is at least one type of elements of Pt, Pd, Ir, Rh, Ru, Os, Ni, and Fe) alloy is disposed with a film thickness of about 5 angstroms or more and 50 angstroms or less under the above-described pinned magnetic layer 4.

The magnetoelastic energy is increased by increasing the magnetostrictive constant λs of the pinned magnetic layer 4 and, thereby, the uniaxial anisotropy of the pinned magnetic layer 4 is increased. When the uniaxial anisotropy of the pinned magnetic layer 4 is increased, the magnetization of the pinned magnetic layer 4 is strongly pinned in a constant direction, the output of the spin-valve type thin film element is increased, and the stability of output and the symmetry are also improved.

In the spin-valve type thin film element shown in FIG. 4, the magnetostriction-enhancing layer 30 formed from a non-magnetic metal is disposed on a surface opposite to the above-described non-magnetic material layer 5 side of a first pinned magnetic layer 4a constituting the pinned magnetic layer 4 while being in contact with the surface. In this manner, strain is generated in the crystal structure particularly on the bottom surface side of the first pinned magnetic layer 4a, and the magnetostrictive constant Xs of the first pinned magnetic layer 4a is increased. Consequently, the uniaxial anisotropy of the above-described pinned magnetic layer 4 is increased, and the above-described pinned magnetic layer 4 can be strongly pinned in a direction parallel to the height direction (Y direction shown in the drawing) even when the antiferromagnetic layer 3 is not disposed.

In FIG. 4, the spin-valve type thin film element is composed of the above-described laminated film T2 (including the above-described magnetostriction-enhancing layer 30), the bias substrate layers 22, the hard bias layers 23, and the above-described electrode layers 24.

With respect to FIG. 3 and FIG. 4, in particular, the reproducing heads provided with single spin-valve type thin film elements are described. The structures shown in FIG. 3 and FIG. 4 can be applied to reproducing heads provided with a dual spin-valve type thin film element having the laminated film shown in FIG. 2.

FIG. 5 is a partial sectional view of a reproducing head provided with a single spin-valve type thin film element including the laminated film shown in FIG. 1, viewed from the side of a surface facing a recording medium. The above-described single spin-valve type thin film element is of a CPP type.

In contrast to the configuration shown in FIG. 3, no gap layer formed from an insulating material is disposed between the above-described laminated film T1 and the lower shield layer 20 and between the above-described laminated film T1 and the upper shield layer 26 in FIG. 5. The above-described lower shield layer 20 and the upper shield layer 26 function as electrodes, and a current is passed through the above-described laminated film T1 in a direction perpendicular to a film surface of each layer (in a direction parallel to the Z direction shown in the drawing).

In FIG. 5, laminated structures, in which an insulating layer 40, a hard bias layer 23, and an insulating layer 41 are laminated from the bottom in that order, are disposed on both sides of the above-described laminated film T1 in the track-width direction (X direction shown in the drawing). The above-described insulating layers 40 and 41 are layers used for reducing the diversion of the current to both sides of the above-described laminated film T1.

The configuration of the laminated film T1 of the CPP spin-valve type thin film element shown in FIG. 5 may be the structure of the self-pinning type laminated film T2 described with reference to FIG. 4, or be applied to the structure of the laminated film of the dual spin-valve type thin film element shown in FIG. 2. The spin-valve type thin film element shown in FIG. 5 is composed of the laminated film T1, the insulating layers 40 and 41, the hard bias layers 23, the lower shield layer 20, and the upper shield layer 26.

A method for manufacturing the laminated film of the single spin-valve type thin film element shown in FIG. 1 will be described below. FIG. 7 and FIG. 9 are sectional views of the laminated film of the above-described single spin-valve type thin film element during manufacturing steps, viewed from the side of a surface facing a recording medium. FIG. 8 is a schematic diagram showing the state of adsorption of oxygen on a surface of the non-magnetic intermediate layer.

As shown in FIG. 7, a film of each of the substrate layer 1, the seed layer 2, the antiferromagnetic layer 3, and the first pinned magnetic layer 4a and the non-magnetic intermediate layer 4b constituting the pinned magnetic layer 4 is formed by a sputtering method. The material for each layer is as described above. Examples of sputtering methods can include a DC magnetron sputtering method, an RF sputtering method, an ion beam sputtering method, a long-throw sputtering method, and a collimation sputtering method. Individual layers shown in FIG. 7 are laminated sequentially in a vacuum chamber.

In FIG. 7, preferably, the above-described non-magnetic intermediate layer 4b is formed from at least one type of elements of Ru, Rh, Ir, Cr, Re, and Cu. It is more preferable that the above-described non-magnetic intermediate layer 4b is formed from Ru, Rh, Ir, Cr, or Re resistant to oxidizing. In the following description, the above-described non-magnetic intermediate layer 4b is assumed to be formed from Ru.

After the films up to the above-described non-magnetic intermediate layer 4b are formed, a pure Ar gas is introduced into the vacuum chamber, and plasma with a low level of energy, at which sputtering does not occur, is generated on the surface 4b1 of the above-described non-magnetic intermediate layer 4b. Plasma particles come into collision with the above-described surface 4b1 so as to activate Ru atoms present on the above-described surface 4b1 and, thereby, the rearrangement of the atoms on the above-described surface 4b1 is facilitated (a first treatment in the surface modification treatment). In this manner, the surface roughness of the above-described surface 4b1 is reduced. For the condition during the plasma treatment, for example, the high-frequency electric power is set at 30 to 120 W, the Ar gas pressure is set at 0.13 to 3.99 Pa, and the treatment time is set at 30 to 180 seconds.

Very small amounts of oxygen in addition to the pure Ar gas is flowed into the vacuum chamber immediately after the plasma treatment. Since the surface 4b1 of the above-described non-magnetic intermediate layer 4b has been activated by the above-described plasma treatment, oxygen is adsorbed on the above-described surface 4b1 in an atmosphere of a mixed gas of a pure Ar gas and oxygen (a second treatment in the surface modification treatment referring to FIG. 8). When the above-described non-magnetic intermediate layer 4b is formed from a material, e.g., Ru, resistant to oxidizing, an oxidized layer is not generated on the surface 4b1 of the above-described non-magnetic intermediate layer 4b even when the amount of the supply of oxygen is increased by increasing the oxygen flow time, for example. Furthermore, the above-described pure Ar gas (inert gas) is used as a diluent of the oxygen, and the above-described pure Ar gas itself is not involved in the oxygen adsorption. Consequently, only the oxygen may be flowed into the vacuum chamber without using the pure Ar gas, and the surface 4b1 of the above-described non-magnetic intermediate layer 4b may be allowed to adsorb oxygen in an oxygen atmosphere. For the condition during the oxygen flow, for example, the oxygen gas pressure is set at 0.266×10⁻³ to 6.65×10⁻³ Pa, and the oxygen flow time is set at 30 to 180 seconds.

In the step shown in FIG. 9, a pure Ar gas is introduced into the vacuum chamber, and a film of the non-magnetic intermediate layer-side magnetic layer 4c2 is formed by a sputtering method. The above-described non-magnetic intermediate layer-side magnetic layer 4c2 is formed with a film thickness of X angstroms. The above-described non-magnetic intermediate layer-side magnetic layer 4c2 is formed from a magnetic material having a resistivity higher than the resistivity of the non-magnetic material layer-side magnetic layer 4c1. Preferably, the above-described non-magnetic intermediate layer-side magnetic layer 4c2 is formed from a magnetic material containing at least two types of elements of Co, Fe, and Ni. It is more preferable that the above-described non-magnetic intermediate layer-side magnetic layer 4c2 is formed from a CoFe alloy. When the above-described first pinned magnetic layer 4a is also formed from the CoFe alloy, the RKKY interaction generated between the above-described first pinned magnetic layer 4a and the second pinned magnetic layer 4c can be increased.

In the state in which the pure Ar gas is introduced into the vacuum chamber, a film of the non-magnetic material layer-side magnetic layer 4c1 is formed on the above-described non-magnetic intermediate layer-side magnetic layer 4c2 by a sputtering method. The above-described non-magnetic material layer-side magnetic layer 4c1 is formed with a film thickness of Y angstroms. The above-described non-magnetic material layer-side magnetic layer 4c1 is formed from a magnetic material having a resistivity lower than the resistivity of the above-described non-magnetic intermediate layer-side magnetic layer 4c2. Preferably, the above-described non-magnetic material layer-side magnetic layer 4c1 is formed from Co. At this time, the film thicknesses X and Y of the above-described non-magnetic intermediate layer-side magnetic layer 4c2 and the non-magnetic material layer-side magnetic layer 4c1, respectively, are controlled individually in such a way that the film thickness ratio of the non-magnetic intermediate layer-side magnetic layer 4c2 to the above-described second pinned magnetic layer 4c, {X/(X+Y)}×100 (%), becomes within the range of 16% to 50% and the film thickness, (X+Y), of the above-described second pinned magnetic layer 4c becomes within the range of 15 angstroms and 30 angstroms.

By allowing the surface 4b1 of the above-described non-magnetic intermediate layer 4b to adsorb oxygen, the surfactant effect is exerted appropriately, and the interface flatness and the crystallinity of the second pinned magnetic layer 4c laminated on the above-described non-magnetic intermediate layer 4b are improved. When the above-described non-magnetic material layer-side magnetic layer 4c1 is formed from the magnetic material having a resistivity lower than the resistivity of the above-described non-magnetic intermediate layer-side magnetic layer 4c2 and, furthermore, the above-described non-magnetic material layer-side magnetic layer 4c1 is formed from a material resistant to oxidizing as compared with the above-described non-magnetic intermediate layer-side magnetic layer 4c2, in the above-described second pinned magnetic layer 4c, the concentration of very small amounts of oxygen taken therein has a gradient gradually decreasing from the bottom surface toward the top surface of the above-described second pinned magnetic layer 4c.

After the step shown in FIG. 9, films of the non-magnetic material layer 5, the free magnetic layer 6, and the protective layer 10 are formed on the above-described second pinned magnetic layer 4c by a sputtering method. Since the interface flatness and the crystallinity of the second pinned magnetic layer 4c are improved, the interface flatness and the crystallinity of the above-described non-magnetic material layer 5 and the free magnetic layer 6 are also improved appropriately. In this manner, the above-described surfactant effect is exerted on the above-described second pinned magnetic layer 4c, the non-magnetic material layer 5, and the free magnetic layer 6 appropriately.

Since the interface flatness and the crystallinity of the above-described second pinned magnetic layer 4c, the non-magnetic material layer 5, and the free magnetic layer 6 are improved, the mean free path of conduction electrons having up spin is increased and, as a result, the magnetoresistance ratio (ΔR/R) can be increased appropriately.

As described with reference to FIG. 9, by controlling the film thickness ratio of the non-magnetic intermediate layer-side magnetic layer 4c2 to the above-described second pinned magnetic layer 4c, {X/(X+Y)}×100 (%), within the range of 16% to 50%, the magnetoresistance ratio (ΔR/R) can be increased and, in addition, the ΔRs and the minRs can also be increased. Consequently, both the magnetoresistance ratio (ΔR/R) and the reproduction output can be increased appropriately. Preferably, the film thickness ratio of the non-magnetic intermediate layer-side magnetic layer 4c2 to the above-described second pinned magnetic layer 4c, {X/(X+Y)}×100 (%), is controlled within the range of 18.2% to 45.5% because both the magnetoresistance ratio (ΔR/R) and the reproduction output can be increased more appropriately.

As described above, in the present embodiment, a magnetic detection element exhibiting a large magnetoresistance ratio (ΔR/R) and a large reproduction output can be manufactured simply and appropriately by applying the surface modification treatment composed of the first treatment in which the surface 4b1 of the above-described non-magnetic intermediate layer 4b is subjected to the plasma treatment to activate the above-described surface 4b1 and the second treatment in which after the first treatment is completed, the above-described surface 4b1 is allowed to adsorb oxygen, allowing the second pinned magnetic layer 4c to have a structure composed of at least two layers of the non-magnetic material layer-side magnetic layer 4c1 and the non-magnetic intermediate layer-side magnetic layer 4c2, and controlling the materials and the film thicknesses of the above-described non-magnetic material layer-side magnetic layer 4c1 and the non-magnetic intermediate layer-side magnetic layer 4c2 appropriately.

The above-described second pinned magnetic layer 4c may be formed with a laminated structure composed of at least three layers. In such a case, for example, the non-magnetic intermediate layer-side magnetic layer 4c2, the intermediate magnetic layer, the non-magnetic material layer-side magnetic layer 4c1 are formed from their respective materials having resistivities decreasing in that order.

### EXAMPLES

The laminated film of the single spin-valve type thin film element shown in FIG. 1 was manufactured.

The above-described laminated structure was substrate layer 1: Ta/seed layer 2: {Ni_{0.8}Fe_{0.2}}_{40at %} Cr_{60at %}(42)/antiferromagnetic layer 3: IrMn (55)/pinned magnetic layer 4 [first pinned magnetic layer 4a: Fe_{70at %} Cr_{30at %}(14)/non-magnetic intermediate layer 4b: Ru (8.7)/non-magnetic intermediate layer-side magnetic layer 4c2: Fe_{90at %} Cr_{10at %} (X)/non-magnetic material layer-side magnetic layer 4c1: Co (22−X)]/non-magnetic material layer 5: Cu (19)/free magnetic layer 6: [Co_{90at %} Fe_{10at %} (10)/NiFe (32)]/protective layer 10: Ta (30), where at % represents atomic percent and a number in parentheses represents a film thickness in the unit angstrom. Subsequently, hard bias layers and electrode layers were formed on both sides of the above-described laminated film in a track-width direction, so that a CIP spin-valve type thin film element similar to that shown in FIG. 3 was manufactured.

The above-described CIP spin-valve type thin film elements having the same layer structure were manufactured. In one element, the surface 4b1 of the above-described non-magnetic intermediate layer 4b had been subjected to the surface modification treatment (Example). The other element had not been subjected to the surface modification treatment (Comparative example). The condition of the surface modification treatment was as described below.

Ar plasma treatment (first treatment)
high-frequency electric power: 100 W
Ar gas pressure: 2.66 Pa
treatment time: 120 seconds

Oxygen flow treatment (second treatment)
oxygen gas pressure: 1.43×10⁻³ Pa
treatment time: 60 seconds

For each of the CIP spin-valve type thin film element in Example and the CIP spin-valve type thin film element in Comparative example, the magnetization of the second pinned magnetic layer 4c is pinned in the height direction (Y direction shown in the drawing), the magnetization of the first pinned magnetic layer 4a is pinned in a direction opposite to the height direction (in the direction opposite to the Y direction shown in the drawing), an external magnetic field in the height direction is applied to the free magnetic layer 6, the magnetization of which is aligned in the track-width direction, and the minimum magnetoresistance minRs and the variation of magnetoresistance ΔRs of the above-described spin-valve type thin film element were measured when the external magnetic field was strengthened gradually. The magnetoresistance takes on a minimum value when the above-described free magnetic layer 6 faces in the height direction which is the same direction as that of the magnetization of the second pinned magnetic layer 4c (measurement of the minRs). The variation of magnetoresistance ΔRs can be determined by subtracting the above-described minRs from the highest value of the magnetoresistance. Furthermore, since the relationship, magnetoresistance ratio (ΔR/R)=ΔRs/minRs holds, the above-described magnetoresistance ratio (ΔR/R) can be determined by determining the above-described minRs and the ΔRs.

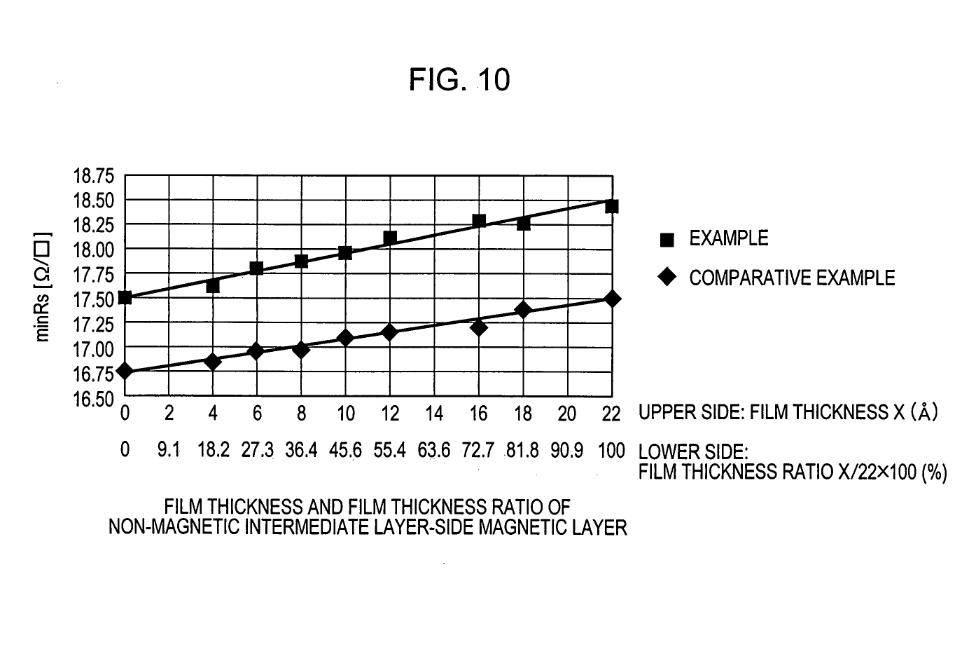

In the experiments, for each of the CIP spin-valve type thin film element in Example and the CIP spin-valve type thin film element in Comparative example, the film thickness X of the non-magnetic intermediate layer-side magnetic layer 4c2 was changed variously while the film thickness of the above-described second pinned magnetic layer 4c was fixed at 22 angstroms, and at that time, the relationships between the film thickness X (absolute value) and the minimum magnetoresistance minRs of the above-described non-magnetic intermediate layer-side magnetic layer 4c2 and between the film thickness ratio and the minRs, the relationships between the film thickness (absolute value) and the variation of magnetoresistance ΔRs of the above-described non-magnetic intermediate layer-side magnetic layer 4c2 and between the film thickness ratio and the ΔRs, and the relationships between the film thickness (absolute value) and the magnetoresistance ratio (ΔR/R) of the above-described non-magnetic intermediate layer-side magnetic layer 4c2 and between the film thickness ratio and the ΔR/R were examined. The experimental results are shown in FIG. 10 to FIG. 12. The above-described film thickness ratio is a value having been rounded off to the first decimal place.

As is clear from FIG. 10, the minRs is increased as the film thickness ratio of the non-magnetic intermediate layer-side magnetic layer 4c2 to the second pinned magnetic layer 4c is increased. This tendency is the same in both Example and Comparative example. However, the value of minRs in Example is larger than that in Comparative example. It is believed that since the non-magnetic intermediate layer-side magnetic layer 4c2 is formed from the CoFe alloy, the non-magnetic material layer-side magnetic layer 4c1 is formed from Co, and the above-described non-magnetic intermediate layer-side magnetic layer 4c2 has a resistivity larger than the resistivity of the non-magnetic material layer-side magnetic layer 4c1, the film thickness ratio of the above-described non-magnetic intermediate layer-side magnetic layer 4c2 is increased and, thereby, the minRs is increased.

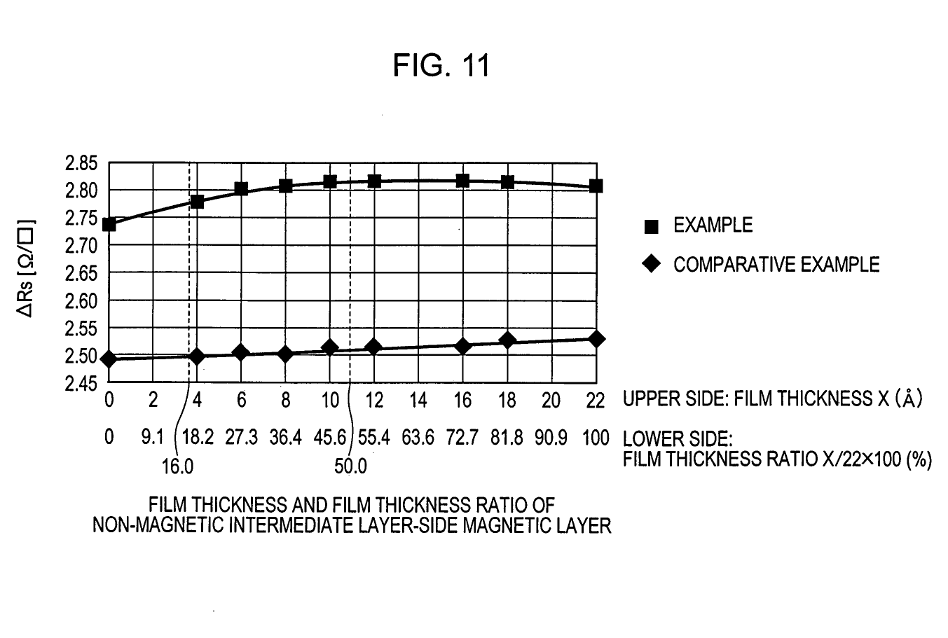

As is clear from FIG. 11, the ΔRs is increased as the film thickness ratio of the non-magnetic intermediate layer-side magnetic layer 4c2 to the second pinned magnetic layer 4c is increased. Furthermore, it is clear that the ΔRs in Example is larger than that in Comparative example.

However, as is clear from FIG. 11, the tendencies of the increase and decrease of ΔRs relative to the film thickness ratio of the above-described non-magnetic intermediate layer-side magnetic layer 4c2 in Example and Comparative example are somewhat different from each other. In Comparative example, it is clear that the above-described ΔRs is increased gradually and linearly as the film thickness ratio of the above-described non-magnetic intermediate layer-side magnetic layer 4c2 to the second pinned magnetic layer 4c is increased.

On the other hand, in Example, as the film thickness ratio of the above-described non-magnetic intermediate layer-side magnetic layer 4c2 to the second pinned magnetic layer 4c is increased, the ΔRs becomes at a maximum when the film thickness ratio of the above-described non-magnetic intermediate layer-side magnetic layer 4c2 reaches about 55% (film thickness is about 12 angstroms), and there is a tendency of the above-described ΔRs to decrease gradually when the film thickness of the above-described non-magnetic intermediate layer-side magnetic layer 4c2 is increased to more than 12 angstroms. As described above, in Example, it is clear that as the film thickness ratio of the non-magnetic intermediate layer-side magnetic layer 4c2 to the second pinned magnetic layer 4c is increased, the ΔRs is increased once, but the above-described ΔRs begins decreasing gradually at a midpoint.

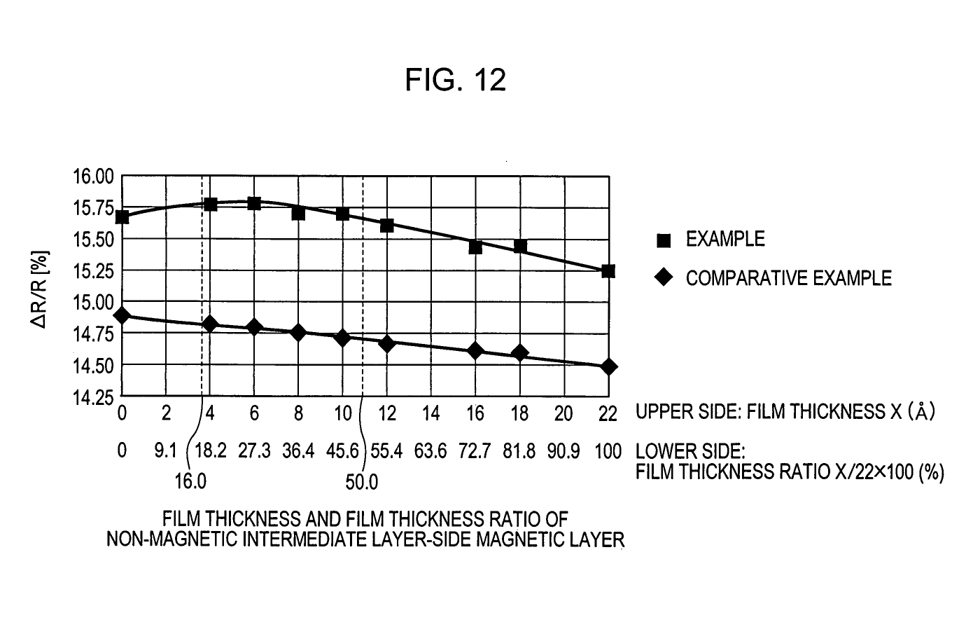

Therefore, the magnetoresistance ratio (ΔR/R) that can be determined by ΔRs/minRs also exhibits a tendency to increase once and begin to decrease gradually at a midpoint as the film thickness ratio of the non-magnetic intermediate layer-side magnetic layer 4c2 to the second pinned magnetic layer 4c is increased (FIG. 12). It is clear from FIG. 12 that the magnetoresistance ratio (ΔR/R) becomes at a maximum when the film thickness ratio of the above-described non-magnetic intermediate layer-side magnetic layer 4c2 is 27.3% (film thickness is about 6 angstroms).

As shown in FIG. 12, in Comparative example, the above-described magnetoresistance ratio (ΔR/R) is decreased gradually and linearly as the film thickness ratio of the non-magnetic intermediate layer-side magnetic layer 4c2 to the second pinned magnetic layer 4c is increased. As described above, in Comparative example, there are complete (clear) trade-off relationships between the magnetoresistance ratio (ΔR/R) and the minRs and between the ΔR/R and the ΔRs. That is, when the film thickness ratio of the non-magnetic intermediate layer-side magnetic layer 4c2, at which the magnetoresistance ratio (ΔR/R) becomes the highest, is selected (that is, the film thickness of the non-magnetic intermediate layer-side magnetic layer is 0 angstroms), conversely, the minRs and the ΔRs tend to become at minimum and, therefore, all the magnetoresistance ratio (ΔR/R), the minRs, and the ΔRs can not be set at large values appropriately.

On the other hand, as is clear from FIG. 12, when the film thickness ratio of the non-magnetic intermediate layer-side magnetic layer 4c2 to the second pinned magnetic layer 4c is set within the range of 16% to 50% in Example, the above-described magnetoresistance ratio (ΔR/R) can be increased and, in addition, the minRs and the ΔRs can also be increased. Furthermore, it is clear that when the film thickness ratio of the above-described non-magnetic intermediate layer-side magnetic layer 4c2 is set within the range of 18.2% to 45.5%, the above-described magnetoresistance ratio (ΔR/R), the minRs, and the ΔRs can be increased more appropriately.

As described above, in the present embodiment, the film thickness ratio of the non-magnetic intermediate layer-side magnetic layer 4c2 to the second pinned magnetic layer 4c is specified to be within the range of 16% to 50%, and more preferable film thickness ratio is specified to be within the range of 18.2% to 45.5%.

What is claimed is:

1. A magnetic detection element comprising a laminated film including a pinned magnetic layer in which the magnetization direction is pinned and a free magnetic layer which is disposed on the pinned magnetic layer with a non-magnetic material layer therebetween and in which the magnetization direction is varied due to an external magnetic field,
wherein at least one predetermined surface of the laminated film, the surface being in a plane direction parallel to the interface between the pinned magnetic layer and the non-magnetic material layer, has been subjected to a first treatment in which the predetermined surface has been activated by a plasma treatment and a second treatment in which the predetermined surface has been exposed to an atmosphere containing oxygen,
the pinned magnetic layer includes a first pinned magnetic layer, a second pinned magnetic layer, and a non-magnetic intermediate layer disposed between the first pinned magnetic layer and the second pinned magnetic layer while the second pinned magnetic layer is disposed on the side in contact with the non-magnetic material layer,
the second pinned magnetic layer includes a non-magnetic intermediate layer-side magnetic layer in contact with the non-magnetic intermediate layer and a non-magnetic material layer-side magnetic layer in contact with the non-magnetic material layer,
the non-magnetic material layer-side magnetic layer is formed from a magnetic material having a resistivity lower than the resistivity of the non-magnetic intermediate layer-side magnetic layer, and
when the film thickness of the non-magnetic intermediate layer-side magnetic layer is assumed to be X angstroms and the film thickness of the non-magnetic material layer-side magnetic layer is assumed to be Y angstroms, {X/(X+Y)}×100 (%) is specified to be 16% or more and 50% or less.

2. The magnetic detection element according to claim 1, wherein the first treatment and the second treatment are applied to the predetermined surface of a layer disposed under any one of the second pinned magnetic layer disposed under the non-magnetic material layer, the free magnetic layer, and a second free magnetic layer when the free magnetic layer has a structure in which a first free magnetic layer, the second free magnetic layer, and a non-magnetic intermediate layer disposed between the first free magnetic layer and the second free magnetic layer are included and the second free magnetic layer is disposed on the side in contact with the non-magnetic material layer.

3. The magnetic detection element according to claim 2, wherein the pinned magnetic layer, the non-magnetic material layer, and the free magnetic layer are laminated in that order from the bottom.

4. The magnetic detection element according to claim 3, wherein the predetermined surface is a surface of the non-magnetic intermediate layer constituting the pinned magnetic layer.

5. The magnetic detection element according to claim 4, wherein the non-magnetic intermediate layer is formed from at least one type of elements of Ru, Rh, Ir, Cr, Re, and Cu.

6. The magnetic detection element according to claim 1, wherein the non-magnetic intermediate layer-side magnetic layer is formed from a magnetic material containing at least two types of elements of Co, Fe, and Ni.

7. The magnetic detection element according to claim 6, wherein the non-magnetic intermediate layer-side magnetic layer is formed from a CoFe alloy.

8. The magnetic detection element according to claim 1, wherein the non-magnetic material layer-side magnetic layer is formed from Co.

9. The magnetic detection element according to claim 1, wherein the second pinned magnetic layer is formed with a film thickness within the range of 15 angstroms or more and 30 angstroms or less.

10. A method for manufacturing a magnetic detection element comprising a laminated film including a pinned magnetic layer in which the magnetization direction is pinned and a free magnetic layer which is disposed on the pinned magnetic layer with a non-magnetic material layer therebetween and in which the magnetization direction is varied due to an external magnetic field, the method comprising the steps of:
subjecting at least one predetermined surface of the laminated film, the surface being in a plane direction parallel to the interface between the pinned magnetic layer and the non-magnetic material layer, to a first treatment in which the predetermined surface is activated by a plasma treatment in a pure Ar atmosphere and, immediately after the first treatment is completed, a second treatment in which the activated predetermined surface is allowed to adsorb oxygen in an atmosphere of oxygen or an atmosphere of a mixed gas of oxygen and an inert gas;
forming the pinned magnetic layer including a first pinned magnetic layer, a second pinned magnetic layer, and a non-magnetic intermediate layer disposed between the first pinned magnetic layer and the second pinned magnetic layer while the second pinned magnetic layer is disposed on the side in contact with the non-magnetic material layer;
forming the second pinned magnetic layer including a non-magnetic intermediate layer-side magnetic layer in contact with the non-magnetic intermediate layer and a non-magnetic material layer-side magnetic layer in contact with the non-magnetic material layer;
forming the non-magnetic material layer-side magnetic layer from a magnetic material having a resistivity lower than the resistivity of the non-magnetic intermediate layer-side magnetic layer, and
when the film thickness of the non-magnetic intermediate layer-side magnetic layer is assumed to be X angstroms and the film thickness of the non-magnetic material layer-side magnetic layer is assumed to be Y angstroms, {X/(X+Y)}×100 (%) is specified to be 16% or more and 50% or less.

11. The method for manufacturing a magnetic detection element according to claim 10, wherein the pinned magnetic layer, the non-magnetic material layer, and the free magnetic layer are laminated in that order from the bottom, the predetermined surface is specified to be a surface of the non-magnetic intermediate layer, and the predetermined surface is subjected to the first treatment and the second treatment.

12. The method for manufacturing a magnetic detection element according to claim 11, wherein the non-magnetic intermediate layer is formed from at least one type of elements of Ru, Rh, Ir, Cr, Re, and Cu.

13. The method for manufacturing a magnetic detection element according to claim 10, wherein the non-magnetic intermediate layer-side magnetic layer is formed from a magnetic material containing at least two types of elements of Co, Fe, and Ni.

14. The method for manufacturing a magnetic detection element according to claim 13, wherein the non-magnetic intermediate layer-side magnetic layer is formed from a CoFe alloy.

15. The method for manufacturing a magnetic detection element according to claim 10, wherein the non-magnetic material layer-side magnetic layer is formed from Co.

16. The method for manufacturing a magnetic detection element according to claim 10, wherein the second pinned magnetic layer is formed with a film thickness within the range of 15 angstroms or more and 30 angstroms or less.
